(19) United States
(12) Patent Application Publication
(10) Pub. No.: US 2023/0421601 A1
(43) Pub. Date: Dec. 28, 2023

(54) MULTI-FACTOR AUTHENTICATION IN ENDPOINT DETECTION AND RESPONSE

(71) Applicant: INTERNATIONAL BUSINESS MACHINES CORPORATION, ARMONK, NY (US)

(72) Inventors: Rosa M. Bolger, Austin, TX (US); Jacobus P. Lodewijkx, Oakton, VA (US); Mauro Marzorati, Lutz, FL (US); Christopher A. Kulakowski, Austin, TX (US)

(21) Appl. No.: 17/808,188

(22) Filed: Jun. 22, 2022

(51) Int. Cl. H04L 9/40

(52) U.S. Cl. CPC H04L 63/1441; H04L 63/1416; H04L 63/1425; H04L 63/08; H04L 2463/082

(57) ABSTRACT

Described are techniques for cybersecurity incident mitigation. The techniques include detecting, by an Endpoint Detection and Response (EDR) function in a networked environment comprising a plurality of endpoints, a security incident on a first endpoint of the plurality of endpoints. The techniques further include identifying an administrator of the first endpoint and initiating a process requiring Multi-Factor Authentication (MFA) associated with the administrator of the first endpoint by transmitting a push notification to a second device associated with the administrator and receiving a response to the push notification from the second device. The techniques further include characterizing, by the EDR function, a maliciousness of the security incident based on the response.

### BACKGROUND

The present disclosure relates to endpoint detection and response (EDR), and, more specifically, to using multi-factor authentication (MFA) to differentiate benign from malicious activity in suspicious behavior detected by EDR.

In complex cloud computing environments, there can be numerous hosts (e.g., nodes, servers, resources, endpoints, etc.) that collaborate together to deliver a desired computing function (e.g., running a website, hosting a database, transmitting stock prices, receiving e-commerce orders, etc.). Administration of such hosts can be distributed amongst many parties in an enterprise (each with a designated skillset). However, the aforementioned computing functions benefit from (or require) a high level of security to protect against cyberattacks, cyberintrusions, ransomware, malware, spyware, and/or other cyber-threats. To address these security risks, EDR systems can be deployed. EDR systems can monitor and manage a plurality of endpoints in a distributed, networked computing environment (e.g., a cloud computing environment). EDR systems can aggregate data from endpoint data collection agents, analyze the aggregated data for security threats, and implement incident response protocols to detected security threats.

### SUMMARY

Aspects of the present disclosure are directed toward a computer-implemented method comprising detecting, by an Endpoint Detection and Response (EDR) function in a networked environment comprising a plurality of endpoints, a security incident on a first endpoint of the plurality of endpoints. The method further comprises identifying an administrator of the first endpoint. The method further comprises initiating a process requiring Multi-Factor Authentication (MFA) associated with the administrator of the first endpoint by transmitting a push notification to a second device associated with the administrator and receiving a response to the push notification from the second device. The method further comprises characterizing, by the EDR function, a maliciousness of the security incident based on the response.

Additional aspects of the present disclosure are directed to systems and computer program products configured to perform the method described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example computational environment implementing EDR software with MFA functionality, in accordance with some embodiments of the present disclosure.

FIG. 2A illustrates a flowchart of an example method for utilizing EDR software with MFA functionality to resolve ambiguous security incidents, in accordance with some embodiments of the present disclosure.

FIG. 2B illustrates a flowchart of an example method for initiating a process requiring MFA to resolve an ambiguous security incident detected by EDR software, in accordance with some embodiments of the present disclosure.

FIG. 3A illustrates a flowchart of an example method for verifying a liveness of administrators associated with endpoints in an MFA functionality, in accordance with some embodiments of the present disclosure.

FIG. 3B illustrates a flowchart of an example method for dispositioning an ambiguous security incident based on a MFA response, in accordance with some embodiments of the present disclosure.

FIG. 4 illustrates a flowchart of an example method for downloading, deploying, metering, and billing usage of EDR software with MFA functionality, in accordance with some embodiments of the present disclosure.

FIG. 5 illustrates a block diagram of an example computer, in accordance with some embodiments of the present disclosure.

FIG. 6 depicts a cloud computing environment, in accordance with some embodiments of the present disclosure.

FIG. 7 depicts abstraction model layers, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward endpoint detection and response (EDR), and, more specifically, to using multi-factor authentication (MFA) to differentiate benign from malicious activity in suspicious behavior detected by EDR. While not limited to such applications, embodiments of the present disclosure may be better understood in light of the aforementioned context.

EDR can perform automated mitigation of security incidents that satisfy predefined rules. However, for security incidents that are suspicious but do not satisfy the predefined rules, the security incidents can be transmitted to a security administrator for review. The security administrator may be required to manually lookup administrators of one or more possibly compromised hosts, contact the administrator(s), and wait to receive feedback from the administrator(s) before making a final disposition of the security incident. This process is inefficient and can last hours or days.

Aspects of the present disclosure are directed to overcoming the aforementioned challenges by using preexisting MFA functionality associated with each endpoint to perform an automated verification process with an administrator of any endpoint on which an ambiguous security incident is detected. For example, in response to an EDR system detecting an ambiguous security incident on a first endpoint of a distributed, networked computing environment, aspects of the present disclosure can send a push notification using MFA functionality associated with the first endpoint to one or more administrators of the first endpoint. Aspects of the present disclosure are then configured to characterize a maliciousness of the ambiguous security incident based on a response to the push notification. For example, the push notification may include options to “allow” or “deny” a process associated with the first endpoint. In response to a positive response (e.g., allow), aspects of the present disclosure can disregard the ambiguous security incident. In response to a negative response (e.g., deny), aspects of the present disclosure can characterize the ambiguous security incident as a cyberthreat and mitigate the cyberthreat (e.g., by isolating the first endpoint by disconnecting the first endpoint from the network, by terminating a process, etc.).

Aspects of the present disclosure realize numerous advantages. For one, aspects of the present disclosure can reduce the time to resolve ambiguous security incidents. For example, using traditional methods might require hours or days to identify, contact, and hear from the necessary administrators. Meanwhile, aspects of the present disclosure can achieve similar results in seconds or minutes by relying on a pre-existing (or newly augmented) MFA functionality. Reducing time to resolve ambiguous security incidents limits potential damage from a cyberattack while also reducing downtime (and thereby increasing efficiency) of the endpoint(s) in question. Reducing time to resolve ambiguous security incidents also reduces the amount of manual oversight needed by an EDR system.

As another example advantage, aspects of the present disclosure do not require an EDR system to maintain a database associating administrators with endpoints insofar as associations between administrators and endpoints are maintained by the MFA system. In this way, aspects of the present disclosure remove a redundant database that requires resources to populate and maintain and instead utilizes pre-existing (or newly augmented) information in an MFA functionality.

As yet another example advantage, aspects of the present disclosure can reduce the frequency of precautionary mitigation actions (e.g., isolated endpoints, terminated processes, etc.) from ambiguous security incidents. For example, using traditional methods requiring time to manually identify and contact appropriate endpoint administrators to resolve and ambiguous security incidents, a suspect endpoint may be temporarily isolated as a precautionary measure. However, such precautionary measures degrade capacity and efficiency of the networked environment. Accordingly, insofar as aspects of the present disclosure reduce the time to resolve ambiguous security incidents using MFA, aspects of the present disclosure likewise reduce the need to implement precautionary mitigation actions.

Further still, aspects of the present disclosure improve the security posture of a networked environment. For example, aspects of the present disclosure incorporate the security benefits of MFA into the detection and response protocol of the EDR system. Further, aspects of the present disclosure improve the security posture of the networked environment by reducing the interval between detection of and resolution of an ambiguous security incident, thereby limiting an amount of time an exploit can be deployed in the networked environment.

Finally, aspects of the present disclosure can be especially beneficial for resolving ambiguous security incidents occurring on servers of a cloud environment. For example, individual servers in a cloud environment can have numerous administrators, where the numerous administrators can be frequently updated. Furthermore, it can be more difficult to identify an administrator of a server compared to an administrator for a laptop, for example. However, aspects of the present disclosure utilize MFA functionality to automatically identify, periodically update, and utilize administrators of respective servers for resolving ambiguous security incidents on particular servers in a cloud environment.

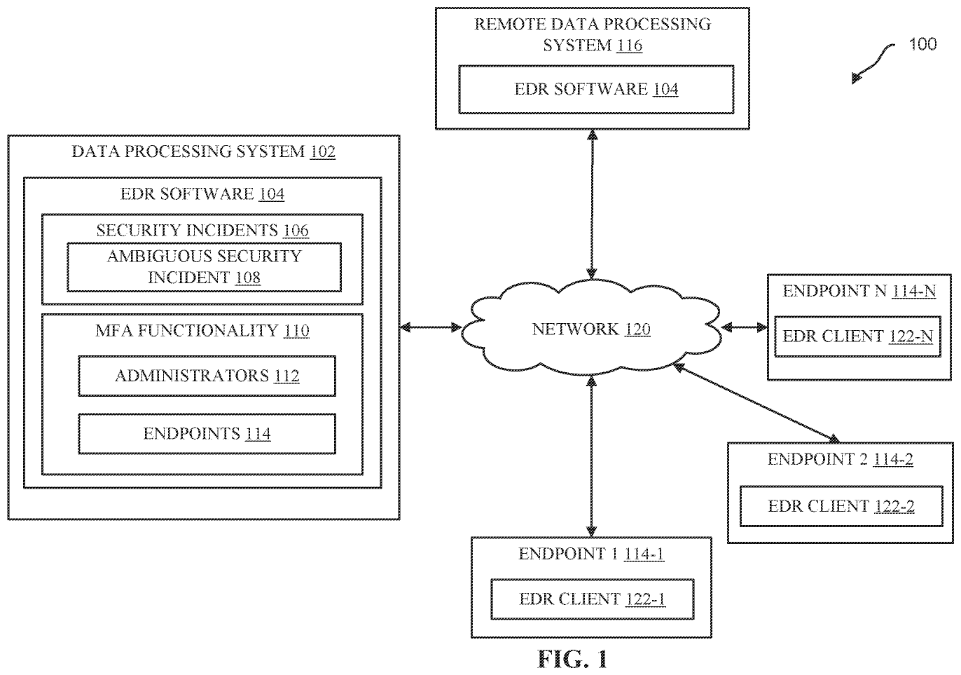

Referring now to the figures, FIG. 1 illustrates a block diagram of an example computational environment 100 implementing EDR software 104 with MFA functionality 110, in accordance with some embodiments of the present disclosure. The computational environment 100 includes a data processing system 102, remote data processing system 116, and endpoints 114 (e.g., endpoint 1 114-1, endpoint 2 114-2, and endpoint N 114-N, where N is any positive integer greater than or equal to one) communicatively coupled to one another via a network 120. The network 120 can be a local area network (LAN), a wide area network (WAN), an intranet, the Internet, or any other network 120 or group of networks 120 capable of continuously, semi-continuously, or intermittently connecting (directly or indirectly) the aforementioned components together. In some embodiments, endpoints 114 represent a cloud environment (whether public, private, or hybrid) that aggregates storage, compute, and networking resources from numerous endpoints 114 and collectively deploys the aggregated resources (e.g., via Virtual Machines (VMs), containers, bare metal, etc.) to serve computational tasks.

EDR software 104 with MFA functionality 110 can be executed on the data processing system 102. In some embodiments, the EDR software 104 with MFA functionality 110 is downloaded to the data processing system 102 from a remote data processing system 116. In other embodiments, some aspects of the EDR software 104 with MFA functionality 110 are implemented by the data processing system 102 and other aspects of the EDR software 104 with MFA functionality 110 are implemented by the remote data processing system 116.

The EDR software 104 with MFA functionality 110 can be configured to detect security incidents 106. EDR software 104 can encompass any EDR, Security Information and Event Management (STEM) system, Intrusion Detection System (IDS), Network Intrusion Detection System (NIDS), Host Intrusion Detection System (HIDS), Intrusion Prevention System (IPS), other cybersecurity detection, prevention, and/or mitigation systems, and/or a combination of any of the aforementioned systems, now known or later developed. Security incidents 106 can be detected using any techniques now known, or later developed, for detecting and/or predicting actual, possible, and/or anticipated security incidents 106. Security incidents 106 can comprise anomalies (e.g., an unexpected process), patterns (e.g., a suspicious sequence of events), matches (e.g., a hash of a file matching a hash of a known malicious file), and/or other types of events. Security incidents 106 can generally be related to components of a networked environment (e.g., data stored in the networked environment, data transmitted amongst the networked environment, processes implemented in the networked environment, etc.).

In some embodiments, EDR software 104 can be configured to implement EDR clients 122 (e.g., EDR client 122-1, EDR client 122-2, and EDR client 122-N) on respective endpoints 114. In such embodiments, the EDR clients 122 executed on the endpoints 114 can be in a client/server relationship with EDR software 104 executed on the data processing system 102. In some embodiments, EDR clients 122 can be implemented as kernel extensions configured to interact with EDR software 104 on the data processing system 102. EDR clients 122 can be configured to collect data from the endpoints, format the data, and/or transmit the data the EDR software 104 on the data processing system 102.

EDR software 104 can classify security incidents 106 as benign (e.g., not an actual cybersecurity threat) or malicious (e.g., an actual cybersecurity threat) using predefined tools, techniques, and/or processes. However, a subset of security incidents 106 comprise ambiguous security incidents 108. Ambiguous security incident 108 can be a security incident that is EDR software 104 is incapable of confidently classifying as benign or malicious using predefined tools, techniques, and/or processes. For such ambiguous security incidents 108, aspects of the present disclosure implement MFA functionality 110 to characterize a maliciousness of the ambiguous security incidents 108.

MFA functionality 110 can refer to any MFA functionality now known or later developed. In general, MFA functionality 110 can be configured to trigger a notification (e.g., by email, text message, phone call, application, website, popup, etc.) requiring input of something known (e.g., password, Personal Identification Number (PIN), code words, etc.), something possessed (e.g., smartphones, laptops, tablets, Universal Serial Bus (USB) drives, token devices, etc.), and/or something biometric (e.g., fingerprint, facial recognition, retina scan, iris scan, voice verification, etc.) seeking secondary authorization to proceed with a process on a device associated with a same user. In this way, MFA functionality 110 requires multiple layers of authorization to proceed with some types of tasks, thereby enhancing the security posture of devices associated with a user. Example MFA functionalities 110 include, but are not limited to, Cisco® Duo Security, Idaptive® MFA, Okta® Adaptive MFA, OneLogin, OneSpan®, Ping Identity® MFA, RSA® SecurID® Access, SecureAuth® Identity Platform, Symantec® VIP, and WatchGuard® Authpoint® MFA, among others.

The MFA functionality 110 includes associations between administrators 112 and endpoints 114. Administrators 112 can include user identities and user authentication characteristics (e.g., passwords, biometrics, etc.). Endpoints 114 can identify specific storage, compute, and/or networking resources, whether physical or virtualized. MFA functionality 110 includes associations between administrators 112 and endpoints 114, where the associations represent which administrators 112 have administrator rights for which endpoints 114. There can be one-to-many, many-to-one, and/or many-to-many relationships between administrators 112 and endpoints 114.

In response to detecting an ambiguous security incident 108, the EDR software 104 can implement MFA functionality 110. The MFA functionality 110 can identify one or more endpoints 114 associated with the ambiguous security incident 108. The MFA functionality 110 can then identify one or more administrators 112 of the suspect endpoints 114. The MFA functionality 110 can then transmit, to at least one of the one or more administrators 112 of the suspect endpoints 114, a push notification requiring authorization via multi-factor authentication. The push notification can be provided by email, text message, phone call, application, website, popup, or another push notification mechanism. The multi-factor authentication technique can be related to something known, something possessed, and/or something inherent, as previously discussed.

The EDR software 104 can then characterize a maliciousness of the ambiguous security incident 108 based on a response received at the MFA functionality 110. For example, if the response indicates an authorization, then the EDR software 104 can characterize the ambiguous security incident 108 as relatively less dangerous (e.g., relatively more benign) and disposition the ambiguous security incident 108 according to protocols for relatively less dangerous security incidents 106. If the response indicates denial of authorization, then the EDR software 104 can characterize the ambiguous security incident 108 as relatively more dangerous (e.g., relatively more malicious) and disposition the ambiguous security incident 108 according to protocols for relatively more dangerous security incidents 106. In some embodiments, a lack of a response can be treated as a denial of authorization and treated accordingly. In embodiments where multiple push notifications are submitted to multiple administrators 112 associated with one or more suspect endpoints 114, the multiple responses can be cumulatively considered by the EDR software 104.

The data processing system 102, the remote data processing system 116, and endpoints 114 can be any computer, server, mainframe, virtual machine (VM), container, tablet, notebook, smartphone, other computer hardware (physical or virtualized), multiples of the aforementioned, and/or combinations of the aforementioned. As will be appreciated by one skilled in the art, FIG. 1 is representative of some embodiments of the present disclosure but should not be construed as limiting. In other embodiments, more or fewer similar or dissimilar components than the components shown in FIG. 1 can be present. Furthermore, in various embodiments, the components shown in FIG. 1, if they are present at all, can be combined together into unified components or separated into discrete components. As one example, the MFA functionality 110 need not be contained within EDR software 104. For example, MFA functionality 110 can be linked to, called by, or otherwise communicatively coupled to EDR software 104. In such embodiments, EDR software 104 can be provided by a first vendor and MFA functionality 110 can be provided by a second vendor with one or more Application Programming Interfaces (APIs) connecting the EDR software 104 to the MFA functionality 110.

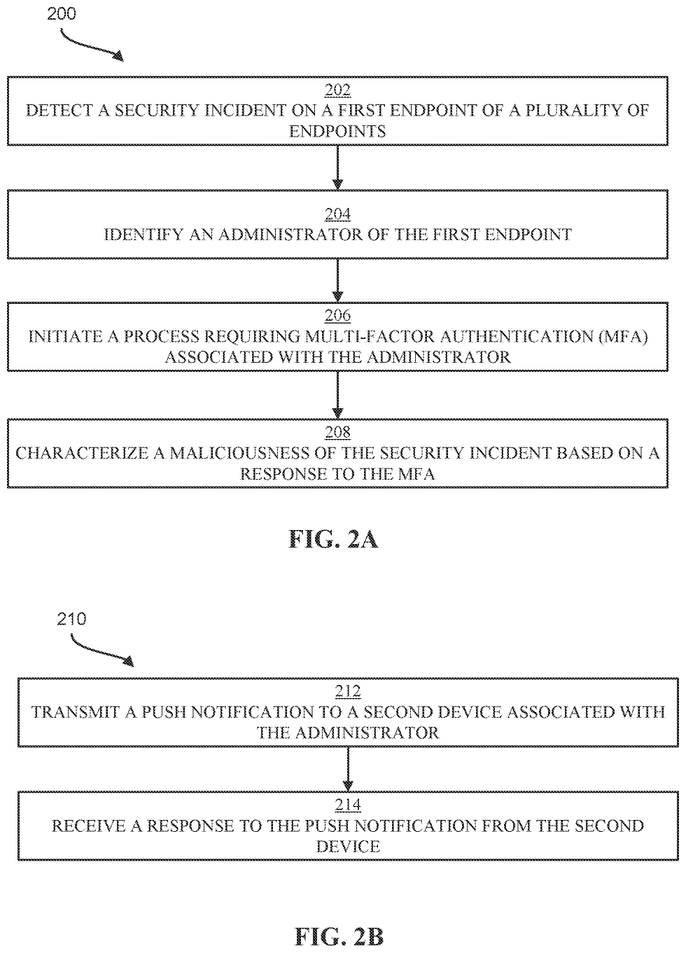

FIG. 2A illustrates a flowchart of an example method 200 for utilizing EDR software with MFA functionality to resolve ambiguous security incidents, in accordance with some embodiments of the present disclosure. The method 200 can be implemented by, for example, the data processing system 102, the remote data processing system 116, a processor, a computer, and/or another combination of hardware and/or software.

Operation 202 includes detecting a security incident (e.g., security incident 106 or ambiguous security incident 108 of FIG. 1) on a first endpoint of a plurality of endpoints (e.g., endpoints 114 of FIG. 1). Operation 202 can detect the security incident using an EDR system (e.g., EDR software 104 of FIG. 1). In some embodiments, operation 202 further comprises pausing processes associated with the security incident. Processes can be paused using, for example Microsoft® User Account Control (UAC), Linux® Trusted Computing Base (TCB), and process threading, among others.

Operation 204 includes identifying an administrator (e.g., administrator 112 of FIG. 1) of the first endpoint. In some embodiments, operation 204 utilizes an associated MFA functionality (e.g., MFA functionality 110 of FIG. 1) to identify the administrator associated with the endpoint.

Operation 206 includes initiating a process requiring MFA associated with the administrator. Processes requiring MFA can include, but are not limited to, local logins, remote Secure Shell (SSH) protocols, and switch user actions, among others. In other embodiments, the identification of an ambiguous security incident can, itself, trigger the MFA functionality.

Operation 208 includes characterizing a maliciousness of the security incident based on a response to the MFA. For example, an authorize response can indicate relatively lower degree of maliciousness of the security incident (e.g., system maintenance, error resolution, installation and/or deployment of software, security patching, etc.) while a deny response can indicate a relatively higher degree of maliciousness of the security incident.

FIG. 2B illustrates a flowchart of an example method 210 for initiating a process requiring MFA to resolve an ambiguous security incident detected by EDR software, in accordance with some embodiments of the present disclosure. The method 210 can be implemented by, for example, the data processing system 102, the remote data processing system 116, a processor, a computer, and/or another combination of hardware and/or software. In some embodiments, the method 210 is a sub-method of operation 206 of FIG. 2A.

Operation 212 includes transmitting a push notification to a second device associated with the administrator. The push notification can be transmitted to the second device as, for example, an email, a text message, a phone call, an application, a website, a popup, or another push notification mechanism.

Operation 214 includes receiving a response to the push notification from the second device. In some embodiments, the response is a binary response (e.g., “approve” or “deny”, “yes” or “no”, “known” or “unknown”). In other embodiments, additional responses to the aforementioned are possible (e.g., “don't know”, “unsure”, “wrong contact”, etc.). Furthermore, in some embodiments, a lack of any response within a time period can, itself, be considered a response. For example, a lack of a response after ten minutes can be characterized as a negative response (e.g., “deny”, “no”, “unknown”, etc.) or an ambiguous response (e.g., “don't know”, “unsure”, “wrong contact”, etc.).

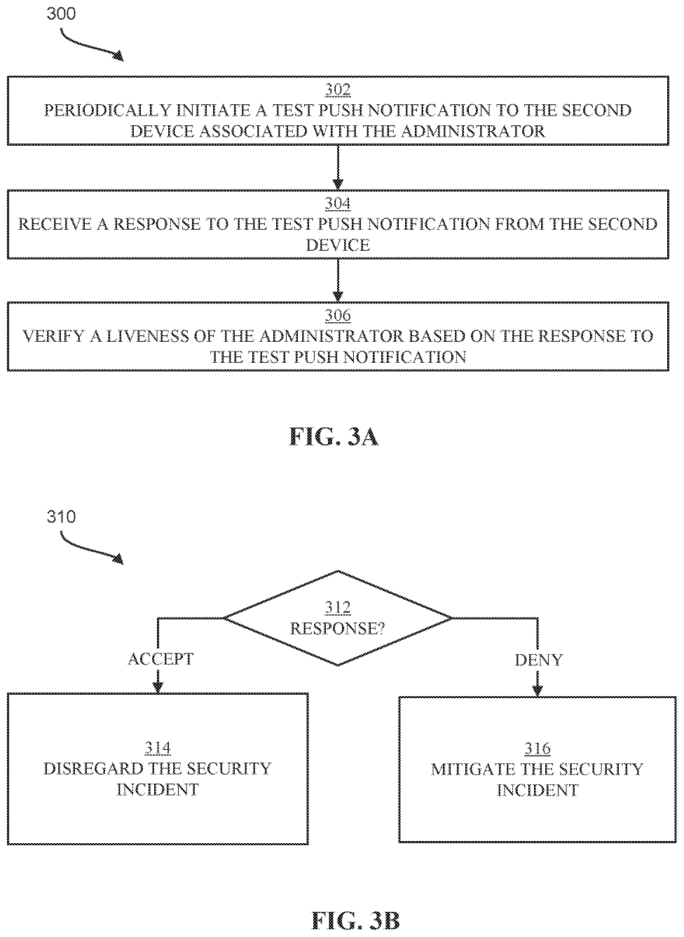

FIG. 3A illustrates a flowchart of an example method 300 for verifying a liveness of administrators associated with endpoints in an MFA functionality, in accordance with some embodiments of the present disclosure. The method 300 can be implemented by, for example, the data processing system 102, the remote data processing system 116, a processor, a computer, and/or another combination of hardware and/or software. In some embodiments, the method 300 is a sub-method of operation 204 of FIG. 2A. In some embodiments, the method 300 can be referred to as an electronic dead-man switch configured to maintain accurate associations between administrators and endpoints in an MFA functionality.

Operation 302 includes periodically initiating a test push notification to the second device associated with the administrator. The test push notification can function to intermittently verify a liveness of the administrator, thereby ensuring associations between administrators and endpoints remain up-to-date and accurate. The test push notification can be transmitted weekly, monthly, or at any other predetermined or random interval of time.

Operation 304 includes receiving a response to the test push notification from the second device. The response can be a traditional binary response as previously described. However, in other embodiments, the response can include options customized for the test push notification such as, for example, “I am an administrator of endpoint x” or “I am not an administrator of endpoint x” where “x” is used to indicate an identifier of a given endpoint.

Operation 306 includes verifying a liveness of the administrator based on the response to the test push notification. For example, an affirmative response can cause the method 300 to retain the administrator and second device as updated associations with the first endpoint. In contrast, a negative response or lack of any response can cause the method 300 to delete the administrator and/or second device as associations with the first endpoint.

While the method 300 is described with respect to a single administrator, a single secondary device, and a single first endpoint, the method 300 can be implemented for any or all administrators, secondary devices, and/or endpoints associated with an MFA functionality. In this way, the method 300 can proactively verify and, if necessary, update associations between administrators and endpoints. Updated associations between administrators and endpoints can advantageously contribute to reduced time to resolution of ambiguous security incidents requiring disposition by MFA responses.

Furthermore, the method 300 can be selectively deployed for administrators without activity (e.g., login activity, usage activity, etc.) for a predetermined period of time (e.g., two weeks, one month, etc.). Doing so can reduce overhead associated with verifying liveness of administrators while retaining much of the operational advantage realized by the method 300.

FIG. 3B illustrates a flowchart of an example method 310 for dispositioning an ambiguous security incident based on a MFA response, in accordance with some embodiments of the present disclosure. The method 310 can be implemented by, for example, the data processing system 102, the remote data processing system 116, a processor, a computer, and/or another combination of hardware and/or software. In some embodiments, the method 310 is a sub-method of operation 208 of FIG. 2A.

Operation 312 determines a type of response received from the MFA functionality. For an “accept” response (e.g., any response indicating approval), the method 310 proceeds to operation 314 and disregards the security incident as benign. For a “deny” response (e.g., any response indicating denial, uncertainty, or a lack of any response), the method 310 proceeds to operation 316 and mitigates the security incident. Operation 316 can mitigate the security incident by, for example, generating and/or transmitting a notification, isolating the suspect endpoint from the network, terminating a suspicious process, or the like.

As will be appreciated by one skilled in the art, additional rules can be applied to the method 310 such that an “accept” response does not automatically characterize the security incident as benign and a “deny” response does not automatically characterize the security incident as malicious. For example, the MFA response can be but one of many factors which are cumulatively considered according to predefined rules and/or trained machine learning models to ultimately disposition a security incident as benign, malicious, or requiring further investigation.

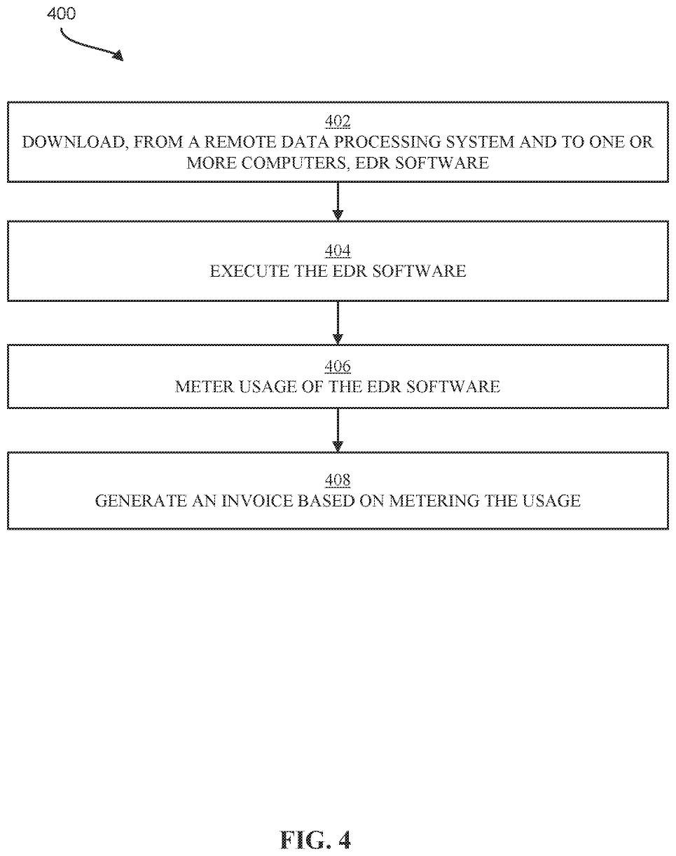

FIG. 4 illustrates a flowchart of an example method 400 for downloading, deploying, metering, and billing usage of EDR software with MFA functionality, in accordance with some embodiments of the present disclosure. The method 400 can be implemented by, for example, the data processing system 102, the remote data processing system 116, a processor, a computer, and/or another combination of hardware and/or software. In some embodiments, the method 400 occurs contemporaneously with any of the previously described methods.

Operation 402 includes downloading, from a remote data processing system (e.g., remote data processing system 116 of FIG. 1) and to one or more computers (e.g., data processing system 102 of FIG. 1), EDR software with MFA functionality (e.g., EDR software 104 with MFA functionality 110 of FIG. 1). Operation 404 includes executing the EDR software with MFA functionality. Operation 404 can include performing any of the methods and/or functionalities discussed herein. Operation 406 includes metering usage of the EDR software with MFA functionality. Usage can be metered by, for example, an amount of time the EDR software with MFA functionality is used, a number of endpoints monitored by the EDR software with MFA functionality, an amount of resources consumed by implementing the EDR software with MFA functionality, and/or other usage metering metrics. Operation 408 includes generating an invoice based on metering the usage.

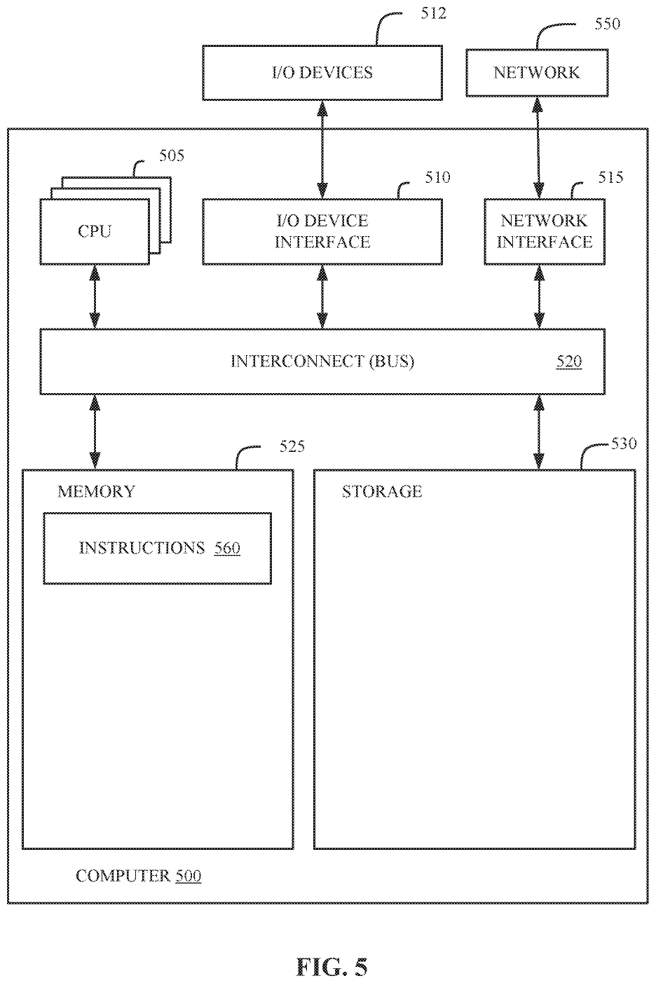

FIG. 5 illustrates a block diagram of an example computer 500 in accordance with some embodiments of the present disclosure. In various embodiments, computer 500 can perform any or all portions of the methods described previously and/or implement any or all portions of the functionalities described previously. In some embodiments, computer 500 receives instructions related to the aforementioned methods and functionalities by downloading processor-executable instructions from a remote data processing system via network 550. In other embodiments, computer 500 provides instructions for the aforementioned methods and/or functionalities to a client machine (e.g., data processing system 102 of FIG. 1) such that the client machine executes the method, or a portion of the method, based on the instructions provided by computer 500. In some embodiments, the computer 500 is incorporated into (or functionality similar to computer 500 is virtually provisioned to) one or more entities illustrated in FIG. 1 and/or other aspects of the present disclosure.

Computer 500 includes memory 525, storage 530, interconnect 520 (e.g., a bus), one or more CPUs 505 (also referred to as processors herein), I/O device interface 510, I/O devices 512, and network interface 515.

Each CPU 505 retrieves and executes programming instructions stored in memory 525 or storage 530. Interconnect 520 is used to move data, such as programming instructions, between the CPUs 505, I/O device interface 510, storage 530, network interface 515, and memory 525. Interconnect 520 can be implemented using one or more buses. CPUs 505 can be a single CPU, multiple CPUs, or a single CPU having multiple processing cores in various embodiments. In some embodiments, CPU 505 can be a digital signal processor (DSP). In some embodiments, CPU 505 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP) CPU configurations). Memory 525 is generally included to be representative of a random-access memory (e.g., static random-access memory (SRAM), dynamic random-access memory (DRAM), or Flash). Storage 530 is generally included to be representative of a non-volatile memory, such as a hard disk drive, solid state device (SSD), removable memory cards, optical storage, or flash memory devices. In an alternative embodiment, storage 530 can be replaced by storage area-network (SAN) devices, the cloud, or other devices connected to computer 500 via I/O device interface 510 or network 550 via network interface 515.

In some embodiments, memory 525 stores instructions 560. However, in various embodiments, instructions 560 are stored partially in memory 525 and partially in storage 530, or they are stored entirely in memory 525 or entirely in storage 530, or they are accessed over network 550 via network interface 515.

Instructions 560 can be computer-readable and computer-executable instructions for performing any portion of, or all of, the methods described previously and/or implementing any portion of, or all of, the functionalities described previously. Although instructions 560 are shown in memory 525, instructions 560 can include program instructions collectively stored across numerous computer-readable storage media and executable by one or more CPUs 505.

In various embodiments, 110 devices 512 include an interface capable of presenting information and receiving input. For example, 110 devices 512 can present information to a user interacting with computer 500 and receive input from the user.

Computer 500 is connected to network 550 via network interface 515. Network 550 can comprise a physical, wireless, cellular, or different network.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

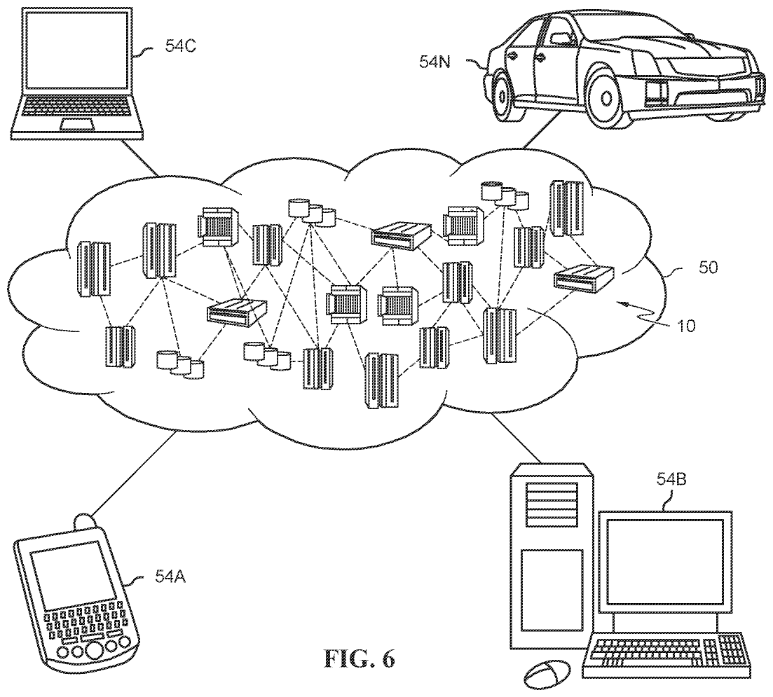

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

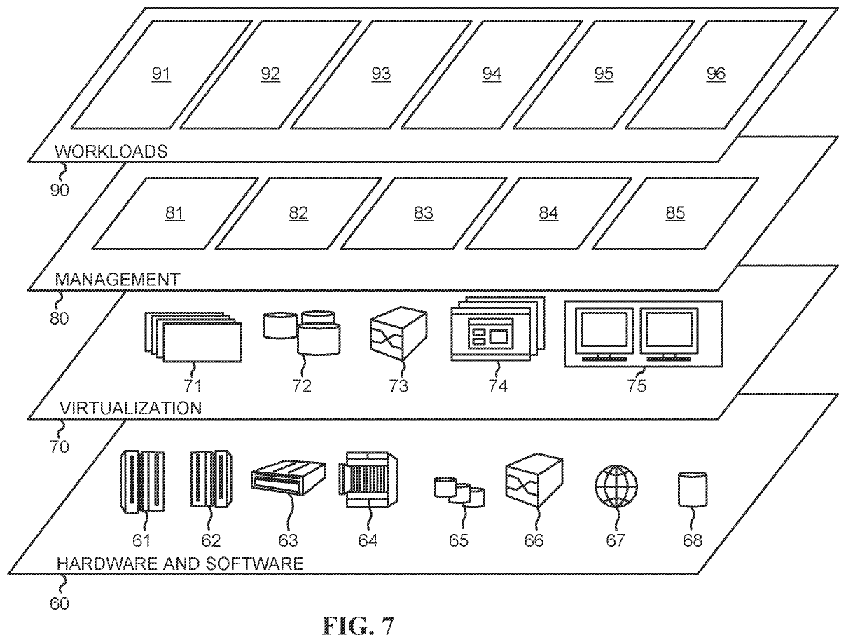

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and EDR software with MFA functionality 96.

Embodiments of the present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any of the instructions stored in instructions 560 of FIG. 5 and/or any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is a computer-implemented method. The method includes detecting, by an Endpoint Detection and Response (EDR) function in a networked environment comprising a plurality of endpoints, a security incident on a first endpoint of the plurality of endpoints; identifying an administrator of the first endpoint; initiating a process requiring Multi-Factor Authentication (MFA) associated with the administrator of the first endpoint by: transmitting a push notification to a second device associated with the administrator; and receiving a response to the push notification from the second device; and characterizing, by the EDR function, a maliciousness of the security incident based on the response.

Example 2 includes the features of Example 1. In this example, the process requiring MFA is selected from a group consisting of: a local login, a remote Secure Shell (SSH) protocol, and a switch-user action.

Example 3 includes the features of any one of Examples 1 to 2. In this example, the first endpoint is a server, and wherein the networked environment is a cloud environment.

Example 4 includes the features of any one of Examples 1 to 3. In this example, the second device is selected from a group consisting of: a desktop, and a smartphone.

Example 5 includes the features of any one of Examples 1 to 4. In this example, the push notification is selected from a group consisting of: a text message, an email, a phone call, an authentication application, a website, and a popup.

Example 6 includes the features of any one of Examples 1 to 5. In this example, the identifying the administrator of the first endpoint comprises: periodically initiating a test push notification to the second device associated with the administrator; receiving a response to the test push notification from the second device; and verifying a liveness of the administrator in response to receiving the response to the test push notification.

Example 7 includes the features of any one of Examples 1 to 6, including or excluding optional features. In this example, the response from the second device denies the push notification, wherein the maliciousness of the security incident is characterized as malicious, and wherein the method further comprises: mitigating the security incident. Optionally, mitigating the security incident comprises isolating the first endpoint from the networked environment. Optionally, mitigating the security incident comprises terminating a process on the first endpoint.

Example 8 includes the features of any one of Examples 1 to 6, including or excluding optional features. In this example, the response from the second device accepts the push notification, wherein the maliciousness of the security incident is characterized as benign, and wherein the method further comprises: disregarding the security incident by allowing the first endpoint to continue functioning in the networked environment.

Example 9 includes the features of any one of Examples 1 to 8, including or excluding optional features. In this example, the method is performed by one or more computers according to software that is downloaded to the one or more computers from a remote data processing system. Optionally, the method further comprises: metering a usage of the software; and generating an invoice based on metering the usage.

Example 10 is a system. The system includes one or more computer readable storage media storing program instructions; and one or more processors which, in response to executing the program instructions, are configured to perform a method according to any one of Examples 1 to 9, including or excluding optional features.

Example 11 is a computer program product. The computer program product includes one or more computer readable storage media, and program instructions collectively stored on the one or more computer readable storage media, the program instructions comprising instructions configured to cause one or more processors to perform a method according to any one of Examples 1 to 9, including or excluding optional features.

What is claimed is:

1. A computer-implemented method comprising:
detecting, by an Endpoint Detection and Response (EDR) function in a networked environment comprising a plurality of endpoints, a security incident on a first endpoint of the plurality of endpoints;
identifying an administrator of the first endpoint;
initiating a process requiring Multi-Factor Authentication (MFA) associated with the administrator of the first endpoint by:
transmitting a push notification to a second device associated with the administrator; and
receiving a response to the push notification from the second device; and
characterizing, by the EDR function, a maliciousness of the security incident based on the response.

2. The method of claim 1, wherein the process requiring MFA is a local login.

3. The method of claim 1, wherein the process requiring MFA is a remote Secure Shell (SSH) protocol.

4. The method of claim 1, wherein the processing requiring MFA is a switch-user action.

5. The method of claim 1, wherein the first endpoint is a server, and wherein the networked environment is a cloud environment.

6. The method of claim 1, wherein the second device is selected from a group consisting of:
a desktop, and a smartphone.

7. The method of claim 1, wherein the push notification is selected from a group consisting of: a text message, an email, a phone call, an authentication application, a website, and a popup.

8. The method of claim 1, wherein the identifying the administrator of the first endpoint comprises:
periodically initiating a test push notification to the second device associated with the administrator;
receiving a response to the test push notification from the second device; and
verifying a liveness of the administrator in response to receiving the response to the test push notification.

9. The method of claim 1, wherein the response from the second device denies the push notification, wherein the maliciousness of the security incident is characterized as malicious, and wherein the method further comprises:
mitigating the security incident.

10. The method of claim 9, wherein mitigating the security incident comprises isolating the first endpoint from the networked environment.

11. The method of claim 9, wherein mitigating the security incident comprises terminating a process on the first endpoint.

12. The method of claim 1, wherein the response from the second device accepts the push notification, wherein the maliciousness of the security incident is characterized as benign, and wherein the method further comprises:
disregarding the security incident by allowing the first endpoint to continue functioning in the networked environment.

13. The method of claim 1, wherein the method is performed by one or more computers according to software that is downloaded to the one or more computers from a remote data processing system.

14. The method of claim 13, wherein the method further comprises:
metering a usage of the software; and
generating an invoice based on metering the usage.

15. A system comprising:
one or more computer readable storage media storing program instructions; and
one or more processors which, in response to executing the program instructions, are configured to perform a method comprising:
detecting, by an Endpoint Detection and Response (EDR) function in a networked environment comprising a plurality of endpoints, a security incident on a first endpoint of the plurality of endpoints;
identifying an administrator of the first endpoint;
initiating a process requiring Multi-Factor Authentication (MFA) associated with the administrator of the first endpoint by:
transmitting a push notification to a second device associated with the administrator; and
receiving a response to the push notification from the second device; and
characterizing, by the EDR function, a maliciousness of the security incident based on the response.

16. The system of claim 15, wherein the identifying the administrator of the first endpoint comprises:
periodically initiating a test push notification to the second device associated with the administrator;
receiving a response to the test push notification from the second device; and
verifying a liveness of the administrator in response to receiving the response to the test push notification.

17. The system of claim 15, wherein the response from the second device denies the push notification, wherein the maliciousness of the security incident is characterized as malicious, and wherein the method further comprises:
mitigating the security incident by one selected from a group consisting of: isolating the first endpoint from the networked environment, and terminating a process on the first endpoint.

18. A computer program product comprising one or more computer readable storage media, and program instructions collectively stored on the one or more computer readable storage media, the program instructions comprising instructions configured to cause one or more processors to perform a method comprising:
detecting, by an Endpoint Detection and Response (EDR) function in a networked environment comprising a plurality of endpoints, a security incident on a first endpoint of the plurality of endpoints;
identifying an administrator of the first endpoint;
initiating a process requiring Multi-Factor Authentication (MFA) associated with the administrator of the first endpoint by:
transmitting a push notification to a second device associated with the administrator; and
receiving a response to the push notification from the second device; and
characterizing, by the EDR function, a maliciousness of the security incident based on the response.

19. The computer program product of claim 18, wherein the identifying the administrator of the first endpoint comprises:
periodically initiating a test push notification to the second device associated with the administrator;
receiving a response to the test push notification from the second device; and
verifying a liveness of the administrator in response to receiving the response to the test push notification.

20. The computer program product of claim 18, wherein the response from the second device denies the push notification, wherein the maliciousness of the security incident is characterized as malicious, and wherein the method further comprises:
mitigating the security incident by one selected from a group consisting of: isolating the first endpoint from the networked environment, and terminating a process on the first endpoint.
